(19) United States
(12) Patent Application Publication
(10) Pub. No.: US 2022/0407356 A1
(43) Pub. Date: Dec. 22, 2022

(54) DUAL-FREQUENCY WIRELESS CHARGER MODULES

(71) Applicant: Apple Inc., Cupertino, CA (US)

(72) Inventor: Makiko Kawamura Brzezinski, Santa Clara, CA (US)

(73) Assignee: Apple Inc., Cupertino, CA (US)

(21) Appl. No.: 17/655,343

(22) Filed: Mar. 17, 2022

Related U.S. Application Data
(60) Provisional application No. 63/202,725, filed on Jun. 22, 2021.

(51) Int. Cl. H02J 50/10; H02J 50/40; H02J 7/00; H02J 50/00; H04B 5/00

(52) U.S. Cl. CPC H02J 50/10; H02J 50/402; H02J 7/0044; H02J 50/005; H04B 5/0037; H02J 50/90

(57) ABSTRACT

A transmitter coil module for inclusion in an accessory device can include a transmitter coil capable of operating at either of two different operating frequencies. The low frequency can be in a range from about 300 kHz to about 400 kHz, and the high frequency can be in a range from about 1 MHz to about 2 MHz. To provide efficient charging at both frequencies, the transmitter coil can be formed from a compound, or multi-stranded, wire. A control module can also be provided that is external to the transmitter coil module The control module can include, for example, a printed circuit board having control circuitry to generate alternating current in the transmitter coil at either the high frequency or the low frequency.

### CROSS-REFERENCES TO RELATED APPLICATIONS

This application claims priority to U.S. Provisional Application No. 63/202,725, filed on Jun. 22, 2021, the disclosure of which is incorporated herein by reference.

### TECHNICAL FIELD

This disclosure relates generally to inductive charging systems and in particular to dual-frequency wireless charger modules that can be incorporated into accessory devices.

### BACKGROUND

Portable electronic devices (e.g., mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, requires the portable electronic device to be physically tethered to a power outlet. Additionally, using a charging cord requires the mobile device to have a connector, typically a receptacle connector, configured to mate with a connector, typically a plug connector, of the charging cord. The receptacle connector includes a cavity in the portable electronic device that provides an avenue via which dust and moisture can intrude and damage the device. Further, a user of the portable electronic device has to physically connect the charging cable to the receptacle connector in order to charge the battery.

To avoid such shortcomings, wireless charging technologies (also referred to as inductive charging technologies) have been developed that exploit electromagnetic induction to charge portable electronic devices without the need for a charging cord. For example, some portable electronic devices can be recharged by merely resting the device on a charging surface of a wireless charger device. A transmitter coil disposed below the charging surface is driven with an alternating current that produces a time-varying magnetic flux that induces a current in a corresponding receiver coil in the portable electronic device. The induced current can be used by the portable electronic device to charge its internal battery.

### SUMMARY

According to some embodiments of the present invention, a wireless charger module can be incorporated into a variety of accessories for charging a portable electronic device. The modular design facilitates assembly of accessories having a variety of form factors and provides a consistent charging experience for the portable electronic device across different accessories. The wireless charger module can include a transmitter coil capable of operating at either of two different operating frequencies, referred to herein as a “low” frequency and a “high” frequency. The low frequency can be in a range from about 300 kHz to about 400 kHz (e.g., about 326 kHz in some embodiments), and the high frequency can be in a range from about 1 MHz to about 2 MHz (e.g., about 1.78 MHz in some embodiments). To provide efficient charging at both frequencies, the transmitter coil can be formed from a compound, or multi-stranded, wire. For instance, a compound wire in a transmitter coil can include a number of strands, where each strand can be a thin (e.g., 30 μm diameter) strand of conductive (e.g., copper) wire having an electrically insulating outer layer. Strands can be twisted around each other to form a set of basic bundles; groups of basic bundles can be twisted around each other to form a set of compound bundles; and the compound bundles can be twisted around each other to form the compound wire. In some embodiments, each basic bundle can include four strands, each compound bundle can include four basic bundles, and the compound wire can include seven compound bundles. A control module can also be provided that is external to the wireless charger module The control module can include, for example, a printed circuit board having control circuitry to generate alternating current in the transmitter coil at either the high frequency or the low frequency.

The following detailed description, together with the accompanying drawings, will provide a better understanding of the nature and advantages of the claimed invention.

### BRIEF DESCRIPTION OF THE DRAWINGS

FIG. 1 shows a perspective view of an electronic device and a wireless charger accessory according to some embodiments.

FIGS. 2A and 2B show front and rear perspective views of a transmitter coil module according to some embodiments.

FIG. 3 shows an exploded view of transmitter coil module according to some embodiments.

FIG. 4 shows a cross-section view of a multi-stranded wire that can be used to form an inductive charging coil according to some embodiments.

FIGS. 5A and 5B show top and bottom views, respectively, of a control module for a transmitter coil module according to some embodiments.

FIGS. 6A-6C are simplified plan views showing examples of connections that can be made to a logic board according to some embodiments.

FIG. 7 shows an exploded view of a cable assembly according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

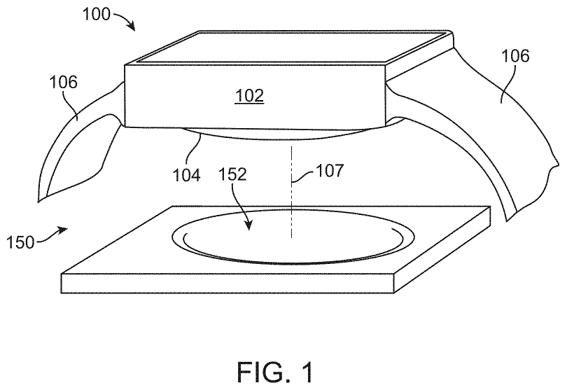

FIG. 1 shows a perspective view of an electronic device 100 and a wireless charger accessory 150 according to some embodiments. Electronic device 100 can include a housing 102 having a magnetically transparent window 104 formed on one surface (e.g., a rear surface). Window 104 can be made of materials such as crystal, glass or polymers, or any other material that permits the transmission of magnetic fields having a frequency in a range used for wireless power transfer (e.g., from about 300 kHz to about 2 MHz), while the rest of housing 102 can be made of other materials such as aluminum, steel, or other metallic or non-metallic materials that may or may not impede transmission of time-varying magnetic fields. Electronic device 100 can also include an electronic display 110 positioned on an opposite side of housing 102 from window 104. In some embodiments, electronic display 110 can take the form of a touch screen configured to display a graphical user interface to a user of electronic device 100. In this example, electronic device 100 can include a wristband 106 for securing electronic device 100 to a wrist of a user. While electronic device 100 is depicted as a wrist-wearable device it should be understood that wireless charging systems of the kind described herein can be incorporated into any type of rechargeable electronic device.

A wireless charger accessory 150 can be used to provide power to electronic device 100 using inductive power transfer. For example, wireless charger accessory 150 can include a transmitter coil (not shown in FIG. 1) and driver circuitry to generate an alternating current in the transmitter coil. Time-varying magnetic fields produced by the alternating current can exit wireless charger accessory 150 through a charging surface 152. Electronic device 100 can have a receiver coil (not shown in FIG. 1) disposed adjacent to window 104. In operation, wireless charger accessory 150 can drive the transmitter coil, thereby generating a time-varying magnetic field, e.g., an oscillating field having a particular frequency. The time-varying magnetic field can induce an electrical current in a receiver coil (not shown in FIG. 1) in electronic device 100, and the electrical current can be used to charge an internal battery of electronic device 100 and/or to supply power to other circuitry within electronic device 100.

Efficiency of wireless power transfer depends on a number of factors, including alignment between the transmitter and receiver coils. In some embodiments, wireless charger accessory 150 and electronic device 100 can include magnetic alignment components (not shown in FIG. 1) to attract and hold the transmitter and receiver coils in a desired alignment. For instance, the desired alignment may align the transmitter and receiver coils along a longitudinal axis 107.

In embodiments described herein, the transmitter coil of wireless charger accessory 150 can operate at either of two different operating frequencies, referred to herein as a “low” frequency and a “high” frequency. The low frequency can be in a range from about 300 kHz to about 400 kHz (e.g., about 326 kHz in some embodiments), and the high frequency can be in a range from about 1 MHz to about 2 MHz (e.g., about 1.78 MHz in some embodiments). Similarly, in embodiments described herein, the receiver coil of electronic device 100 can operate at either the high or low frequency. In some embodiments, the operating frequency for a particular pair of devices used together is determined dynamically, based on the capabilities of the devices. For example, it is contemplated that a family of electronic devices having similar form factors may be provided. The family may include “upgraded” electronic devices that can charge at either the high frequency or the low frequency, as well as “legacy” electronic devices that can charge only at the low frequency. Similarly, a family of wireless charger devices may include upgraded charger devices that can transmit power at either the high frequency or the low frequency and legacy charger devices that can transmit power only at the low frequency. An upgraded charger device can be used to provide power at the high frequency to an upgraded electronic device and to provide power at the low frequency to a legacy electronic device. Likewise, where an upgraded electronic device can receive power at either frequency, the upgraded electronic device can receive power at the high frequency from an upgraded charging device and can receive power at the low frequency from a legacy charging device. In this manner, upgraded electronic devices and chargers can be interoperable with legacy electronic devices and chargers.

Wireless charger accessory 150 can be any accessory that can be used with electronic device 100 and can have any form factor that may be desired. For instance, wireless charger accessory 150 can be a docking station for electronic devices and may also provide charging for other devices at the same time as electronic device 100 is being charged. To facilitate construction of different accessories that provide the same wireless charging performance, some embodiments provide a transmitter coil module (also referred to herein as a “wireless charger module”) that incorporates a transmitter coil and shielding and that has external electrical contacts via which alternating current can be provided to the transmitter coil. The external contacts can be coupled to a control module (e.g., a logic board) that includes the control circuitry to generate AC current for the transmitter coil. The transmitter coil module and control module can be integrated into a variety of accessories. Examples of transmitter coil modules and control modules will now be described.

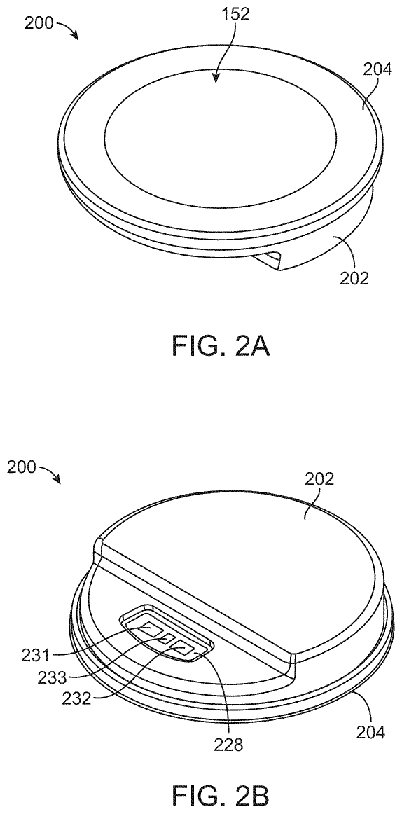

FIGS. 2A and 2B show front and rear perspective views of a transmitter coil module 200 according to some embodiments. Transmitter coil module 200 includes a housing base 202, which can be made of aluminum or other materials as desired. A cap 204 can be shaped to fit over the top of housing base 202 to form an enclosure. In this example, housing base 202 and cap 204 provide a puck-shaped form factor. The top surface of cap 204, which can define charging surface 152, can be planar or can have a non-planar (e.g., concave) portion to accommodate a nonplanar (e.g., convex) charging surface of an electronic device. Housing base 202 and cap 204 can be made of a variety of materials, including materials that are non-corrosive, chemically resistant, and capable of withstanding thermal and mechanical stress. For example, housing base 202 can be made of a metal, metal alloy, ceramic, plastic, or composite material. In various embodiments, housing base 202 can be made of stainless steel or aluminum. Cap 204 can be made of a material that allows time-varying magnetic fields generated within the enclosure formed by cap 204 and housing base 202 to pass through cap 204 with little or no loss. For example, cap 204 can be made of polycarbonate or other plastic, ceramic, or composite. In some embodiments, charging surface 152 can be coated with soft-touch silicone or the like, which can provide a softer contact surface and avoid marring the surface of the device being charged. Other materials that allow transmission of electromagnetic fields in the desired frequency ranges can also be used. In some embodiments, charging surface 152 can be a low-friction surface, and wireless charger accessory 150 can rely on magnetic forces rather than friction for maintaining alignment with a device to be charged. Housing base 202 and cap 204 can be sealed together using an adhesive (e.g., a resin) such that transmitter coil module 200 is resistant to intrusion of liquids (e.g., water).

As shown in FIG. 2B, the rear surface of housing base 202 can include an opening 228 where electrical contacts 231-233 are exposed. As described below, electrical contacts 231-233 can be contact pads formed on a printed circuit board. Contacts 231, 232 can be connected via traces to the ends of a wire that forms a transmitter coil within transmitter coil module 200, while contact 233 can be a ground contact that couples to housing base 202 and/or other components that should be electrically grounded. External wires or other conductors that provide AC current (and ground) can be connected to electrical contacts 231-233.

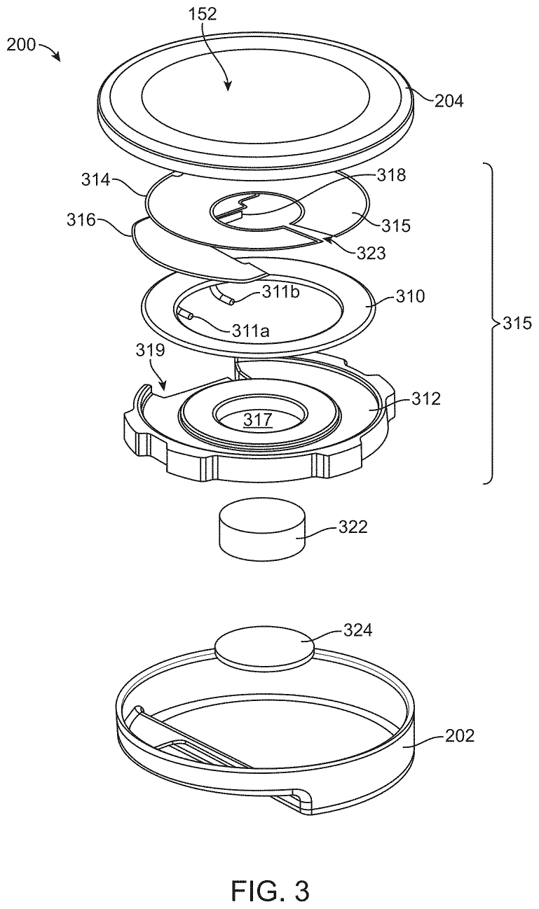

FIG. 3 shows an exploded view of transmitter coil module 200 according to some embodiments. As described above, transmitter coil module 200 includes housing base 202 and cap 204 forming an enclosure. Within the enclosure, a charging coil assembly 315 can include a coil 310, an electromagnetic shield 314, and a ferrimagnetic sleeve 312. Coil 310 can be a coil formed of multiple turns (or windings) of a multi-stranded copper wire (or other electrically conductive and ductile material), with terminals 311a, 311b toward the center of the coil, having a proximal surface oriented toward cap 204 and an opposing distal surface. Further description of coil 310 is provided below.

Ferrimagnetic sleeve 312 can be positioned at the distal side of coil 310 (i.e., the side opposite cap 204). Ferrimagnetic sleeve 312 can be made of ferrimagnetic material (which can be, e.g., a ceramic material that includes iron oxide) with a magnetic permeability (μᵢ) that provides low loss at high charging frequencies (e.g., ˜2 MHz). For example, the ferrimagnetic material can be MnZn with μᵢ˜900. Ferrimagnetic sleeve 312 can be shaped to direct magnetic flux generated by coil 310 toward charging surface 152 and can also provide shielding against electromagnetic emissions through surfaces of transmitter coil module 200 other than charging surface 152. The upper surface of ferrimagnetic sleeve 312 can be contoured to surround the distal and outboard side surfaces of coil 310. Ferrimagnetic sleeve 312 can have a central opening 317. A peripheral pass-through space 319 can be provided to accommodate coil terminals 311a, 311b. In some embodiments, electrically insulating material can be applied to portions of ferrimagnetic sleeve 312 to prevent ferrimagnetic sleeve from electrically contacting and shorting out charging coil 310.

Electromagnetic shield 314 can include a main shield body 315 disposed between cap 204 and coil 310 to provide a capacitive shield that helps to remove coupled noise between transmitter coil module 200 and an electronic device being charged by transmitter coil module 200, including noise that can occur as result of user interaction with a touch-sensitive display on the electronic device. In some embodiments, electromagnetic shield 314 can be made of thin and flexible materials. For example, electromagnetic shield 314 can be formed of a flexible printed circuit board with electrically-conductive material printed or otherwise deposited thereon. An adhesive layer (not shown) can be provided to secure electromagnetic shield 314 in place. In other embodiments, electromagnetic shield 314 can be formed by printing conductive material onto a pressure-sensitive adhesive film. As shown, main shield body 315 can include a slit 223 to prevent eddy currents from forming. Electromagnetic shield 314 can also include an L-shaped extension portion 316 that fits between ferrimagnetic sleeve 312 and housing base 202. Extension portion 316 can be electrically coupled to the main shield body 315. Extension portion 316 can attach to housing body 202 to provide electrical grounding. Second level 316 can have a printed circuit board 318 disposed on an underside thereof. Printed circuit board 318 can include the exposed electrical contacts 230 shown in FIG. 2B. Terminals 311a, 311b of coil 310 can also be coupled to printed circuit board 318 so that current can flow between terminals 311a, 311b and coil 310.

Magnet 322 and DC shield 324 can provide a magnetic alignment structure that can attract a complementary magnetic alignment structure in a portable electronic device to be charged. For example, magnet 322 can be a cylindrical permanent magnet with an axial dipole orientation. DC shield 324 can be made of a material that directs magnetic flux from magnet 322 away from the bottom surface of housing base 202 so that the distal side of transmitter coil module 200 is not strongly magnetized. The height of magnet 322 and DC shield 324 can be equal to a distance between cap 204 and the inner bottom surface of housing base 202, so that magnet 322 does not move axially within transmitter coil module 200 and so that the proximal end of magnet 322 is adjacent to the inner surface of cap 204. Lateral movement of magnet 322 can be constrained by the size of central opening 317 in ferrimagnetic sleeve 312 and/or using other techniques such as adhesives or potting.

Power can be supplied to transmitter coil module 200, and more particularly to coil 310, via contact pads 231-233 on the distal side of extension portion 316 of electromagnetic shield 314. In some embodiments, AC current from an external source is delivered directly to coil 210, and transmitter coil module 200 need not include any active electronic components.

Coil 310 can be capable of operating at high efficiency at two different fundamental frequencies. In some embodiments, the low frequency can be in a range from about 300 kHz to about 400 kHz (e.g., a frequency of 326 kHz), and the high frequency can be in a range from about 1 MHz to about 2 MHz (e.g., a frequency of about 1.78 MHz). As noted above, coil 310 can be formed from a conductive wire wound into multiple turns to form a coil. When alternating current flows through a conductor, the current density tends to be highest near the surface and decrease exponentially nearer the center of the conductor; this is referred to as the “skin effect.” Skin effect, which increases the effective resistance of the conductor, becomes more pronounced as frequency increases, resulting in less efficient operation.

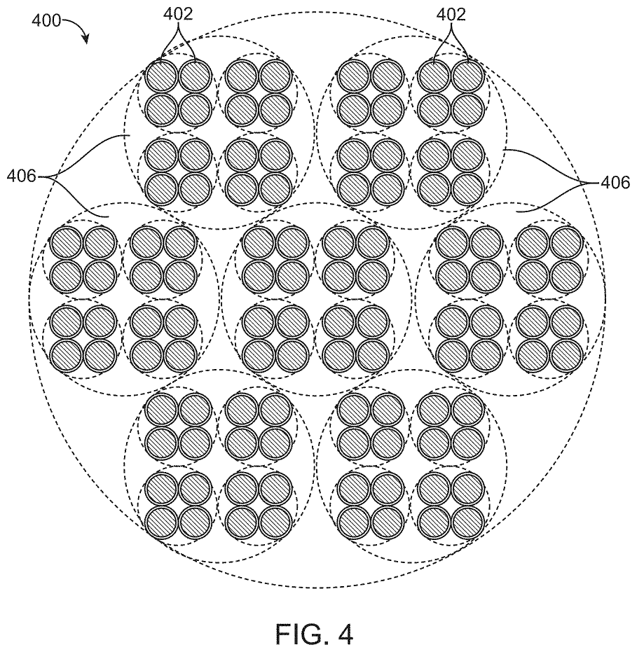

To support efficient operation at high frequency, coil 310 in some embodiments can be made of a compound (multi-stranded) wire. FIG. 4 shows a cross-section view of a multi-stranded wire 400 that can be used to form coil 310 according to some embodiments. Wire 400 is made of many individual strands 402. Each strand 402 can be an extruded length of copper wire (or other electrically conductive and ductile material) having a narrow diameter (e.g., 30 μm, or a diameter in a range from 20-40 μm). Each strand 402 can have an electrically insulating outer layer; for instance, each strand can be coated with a flexible insulating coating or wrapped in an insulating sleeve or jacket. A group of strands 402 can be twisted together along their length to form a basic bundle 404. In the example shown in FIG. 4, each basic bundle 404 includes four strands 402. A group of basic bundles 404 can be twisted together along their length to form a compound bundle 406. In the example shown, each compound bundle 406 includes four basic bundles 404, for a total of sixteen strands per compound bundle 406. A group of compound bundles 406 can be twisted together along their length to form multi-stranded wire 400. In the example shown in FIG. 4, multi-stranded wire 400 includes seven compound bundles 406, for a total of 112 strands in multi-stranded wire 400. A wire formed in this manner has an increased effective “skin” area, allowing for more efficient operation at a high frequency (e.g., around 1.78 MHz) while still providing efficient operation at a low frequency (e.g., around 326 kHz).

Coil 310 can be formed by winding multi-stranded wire 400 in multiple turns to form the desired coil shape. In some embodiments, coil 310 includes one layer of windings in a spiral pattern; however multiple layers of windings can be provided if desired. All windings can lie in the same plane, or coil 310 can have a non-planar shape, e.g., conforming to a concave or other non-planar charging surface 152 of cap 204. In some embodiments, the outer end of wire 400 can cross to the inside of coil 310 so that terminals 311a, 311b are both on the inboard side of coil 310 (as shown in FIG. 3); for instance, the outer end of wire 400 can be routed across the distal side of coil 310.

In embodiments described above, transmitter coil module 200 includes a charging coil 310 and external contact pads 231-233 that provide electrical connections directly to the coil but does not include a current source or active electronic components to drive or control current through the coil. In some embodiments, a control module can be provided separately from transmitter coil module 200, e.g., as part of a wireless charging kit. The control module can be, for example, a printed circuit board having mounted thereon electronic circuitry configured to drive the coil at the desired frequencies. The wireless charging kit can be supplied to a manufacturer of accessories, and the manufacturer of accessories can incorporate transmitter coil module 200 and the control module into an accessory. Examples of a control module for transmitter coil module 200 will now be described.

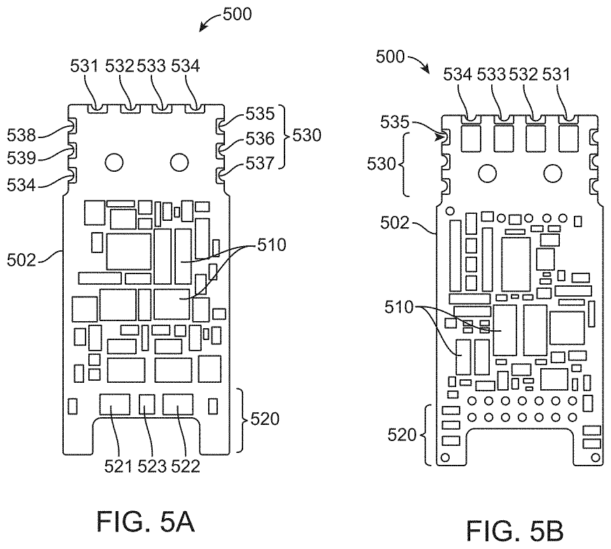

FIGS. 5A and 5B show top and bottom views, respectively, of a control module 500 for transmitter coil module 200 according to some embodiments. In this example, control module 500 is implemented as a logic board 502, which can be a printed circuit board having electronic components 510 mounted thereon. The printed circuit board can be patterned with conductive traces interconnecting electronic components 510. The form factor of logic board 502 can be chosen as desired. In some embodiments, logic board 502 can be made small to facilitate installation in the housing of accessories having a broad range of form factors. For example, logic board 502 can be sized and shaped to fit within a cable boot of a cable, although it should be understood that logic board 502 is not limited to any particular installation location within an accessory device. Electronic components 510 can include a DC-to-AC converter (e.g., an inverter) that converts a received DC current to an AC current, which can be carried on a pair of wires through cable 236 to coil 210. Electronic components 510 can also include control circuitry (e.g., a microcontroller or other logic circuits) to manage operation of the DC-to-AC converter, including determining whether to operate at the high frequency or the low frequency. In some embodiments, electronic components 510 can include monitoring circuitry that monitors power transfer to the receiving device (which may include receiving signals from the receiving device, e.g., via modulation by the receiving device of the electromagnetic field that transfers power to the receiving device), and the selection of operating frequency can be based on the monitoring. Other techniques for selecting an operating frequency can also be used.

A “proximal” end 520 of logic board 502 can include contact pads 521-523 to deliver output current for transmitter coil module 200. For example, contact pads 521-523 can include AC hot, neutral, and ground pads. A three-wire cable can be connected between contact pads 521-523 and contact pads 231-233 of transmitter coil module 200 to provide AC current to coil 310 as well as grounding of housing base 202 and electromagnetic shield 314.

A “distal” end 530 of logic board 502 (opposite proximal end 520) can include contact pads 531-540. In some embodiments, contact pads 531-540 can include contacts supporting standard USB connections. For example, contact pads 531-534 can correspond to USB bus voltage, D+ and D− data signals, and ground, and contact pads 535 and 538 can correspond to USB CC pins (used for USB Type-C connections). Contact pads 531-540 can be castellated to facilitate connections to a USB plug-type connector.

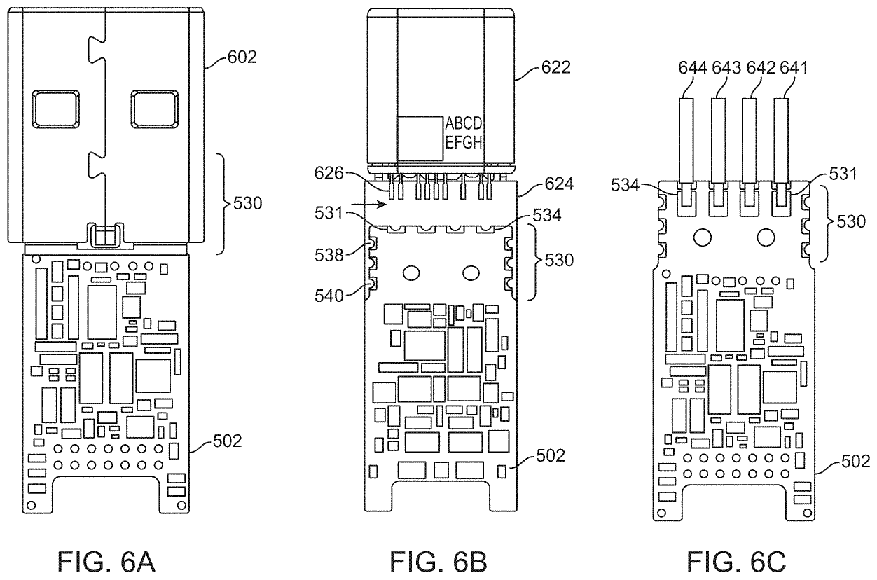

Distal end 530 of logic board 502 can be connected to various devices via which power (e.g., DC power complying with USB standards) and optionally data can be provided to logic board 502. FIGS. 6A-6C are simplified plan views showing examples of connections that can be made to distal end 530 of logic board 502 according to some embodiments. FIG. 6A shows a bottom view of logic board 502 connected to a USB Type-A plug connector 602 according to some embodiments. Distal end 530 is inserted into an outer metal shell of connector 602, and contacts 531-534 can be electrically connected to corresponding USB Type A connector pins (not shown in FIG. 6A) within the connector shell. FIG. 6B shows a bottom view of logic board 502 connected to a USB Type-C plug connector 622 according to some embodiments. An interposer board 624 is connected to contacts 531-540 at distal end 530 of logic board 502 and to connector pins 626 that extend from the rear of USB Type-C plug connector 622. Interposer board 624 can be a printed circuit board (e.g., a flexible printed circuit board) patterned with traces that provide appropriate electrical paths between contacts 531-540 and connector pins 626. FIG. 6C shows a bottom view of logic board 502 connected to a set of contact pins 641-644 according to some embodiments. Contact pins 641-644 can be connected to any circuitry that can provide power, ground and data. Thus, for example, logic board 502 and transmitter coil module 200 can be mounted within an accessory housing, with charging surface 152 exposed and other components hidden. A standard wall-power cable and plug can extend from the accessory housing. Within the accessory housing, a power converter circuit can convert wall power to USB power, and the USB power output of the power converter circuit can be connected to contact pin 641, which is connected to USB power contact 531.

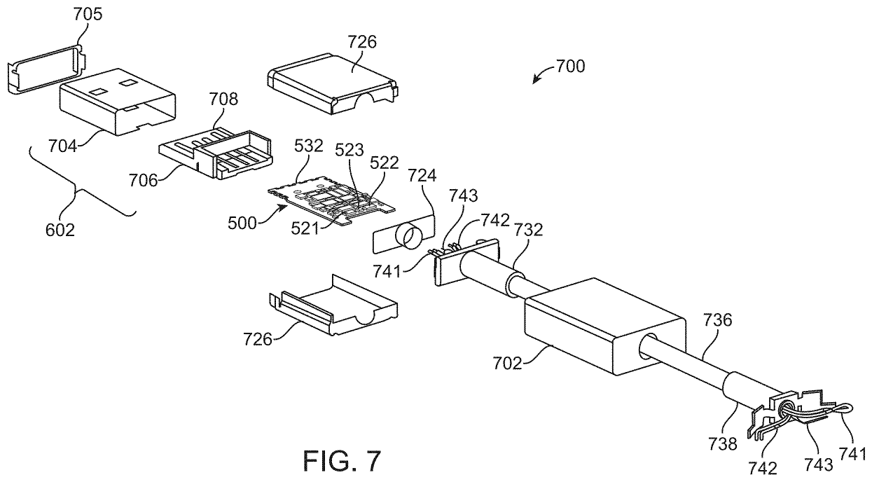

Further illustrating how a control module can be incorporated into a wireless charger accessory, FIG. 7 shows an exploded view of a cable assembly 700 incorporating USB Type-A connector 602 and logic board 502 according to some embodiments. Cable assembly 700 includes AC cable 736, one end of which can be secured to transmitter coil module 200. For example, wires 741-743 (which can act as hot, neutral, and ground wires) within cable 736 can be connected at one end to contact pads 231-233 on the rear side of housing base 202 (shown in FIG. 2). A strain relief component 738 can be provided at or near the connection point if desired. The other end of cable 736 can terminate in a cable boot 702. Cable 736 can be as long as desired (e.g., 1 meter, 2 meters, or any other length). Cable boot 702 can be made of electrically nonconductive material (e.g., plastic, ceramic, polymer, resin) and can have an esthetically pleasing appearance. Cable boot 702 can house logic board 502. The other ends of wires 741-743 can be connected to AC contacts 521-523 of logic board 502. Logic board 502 can be coupled at its distal end to USB Type-A connector 602. As shown in FIG. 7, connector 602 can include a front shell 704 (which can be made of metal), an insulating snout 706 that has electrical contacts 708 disposed thereon, and a faceplate 705. Electrical contacts 708 can be connected to distal-end contacts 531-534 of logic board 502. An EMI shield 726, which can be constructed as a two-piece clamshell as shown, can be disposed within cable boot 702 surrounding logic board 502. EMI shield 726 can reduce or prevent electromagnetic interference between the circuitry of logic board 502 (including the DC-to-AC converter) and other electronic equipment. EMI shield 726 can be made of various materials including conductive and/or magnetic materials. In some embodiments, EMI shield 726 can be constructed as a Faraday cage. EMI shield 726 and the ground pin of snout 706 can be connected to the ground wire of cable 736 to provide a common ground. A boot crimp 724 can hold the distal end of cable 736 in place where cable 736 exits boot 702. If desired, strain relief can be provided using a strain relief element 732 (which can be an external strain-relief sleeve), or using other techniques.

In embodiments described above, a wireless charger accessory incorporating transmitter coil module 200 can operate coil 310 to provide power at either a low frequency (e.g., a frequency of about 326 kHz or other frequency in the range from about 300 kHz to about 400 kHz) or a high frequency (e.g., a frequency of about of 1.78 MHz or other frequency in the range from about 1.5 MHz to about 2 MHz). In some embodiments, power transfer efficiency to a particular electronic device can be around 70% at the low frequency and around 85% at the high frequency. The coil configurations described above provide more efficient magnetic coupling at the high frequency than the low frequency, although the associated electronics may operate slightly less efficiently at the high frequency. In some embodiments, the increased magnetic coupling efficiency at the high frequency can result in significant reductions (e.g., 25% to 50%) in time needed to charge a battery of a portable electronic device at the high frequency as compared to charging at the low frequency. In some embodiments, transmitter coil module 200 operates at the high frequency when providing power to a device capable of receiving power at the high frequency and switches to the low frequency when providing power to other devices (e.g., legacy devices as described above).

In some embodiments, a manufacturer can provide a kit that includes a transmitter coil module (e.g., transmitter coil module 200) and a control module (e.g., logic board 502) as separate, disconnected components. A third party can assemble a wireless charging accessory by connecting logic board 502 to transmitter coil module 200 (e.g., using wires as described above) and enclosing transmitter coil module 200 and logic board 502 in an accessory housing such that charging surface 152 of transmitter coil module 200 is exposed. The accessory housing can have any form factor desired. For example, the housing can follow the puck shape of transmitter coil module 200, and a cable extending therefrom can have a boot that houses logic board 502 (e.g., as shown in FIG. 7). As another example, the housing can have a cuboid (e.g., rectangular cuboid) or cylindrical shape, and logic board 502 can be disposed within the housing. A cable can extend from the housing to allow the user to connect to wall power, to a USB adapter, or to some other power source as desired. In some embodiments, the accessory can include a battery to provide power, and a connection to an external power source is not required.

While the invention has been described with reference to specific embodiments, those skilled in the art will appreciate that variations and modifications are possible. For instance, the transmitter coil module and control module described herein are designed to be compact to fit within accessories having small form factors. The control module can be provided as a printed circuit board with components (e.g., integrated circuits and/or circuit components) mounted thereon, or the circuit board can be enclosed, e.g., within a metal structure such as a Faraday cage that provides electromagnetic shielding and physical protection for the components. A wireless power module and control module of the kind described herein can be incorporated into a variety of accessory devices to provide wireless charging capability, regardless of form factor or other functionality of the accessory device. All dimensions and materials mentioned herein are for purposes of illustration and can be modified. The number of strands in a bundle and number of bundles in a wire can also be varied. Using twisted strands to form a compound wire can simplify manufacturing.

Accordingly, although the invention has been described with respect to specific embodiments, it will be appreciated that the invention is intended to cover all modifications and equivalents within the scope of the following claims.

What is claimed is:

1. A transmitter coil module comprising:
a housing including a cap and a housing base forming an enclosure;
a coil formed of a compound wire wound into a plurality of turns, the coil being disposed in the enclosure,
wherein the compound wire comprises a plurality of strands, wherein subsets of the strands are twisted around each other to form a set of basic bundles, wherein groups of basic bundles are twisted around each other to form a plurality of compound bundles, and wherein the plurality of compound bundles are twisted around each other to form the compound wire; and
a plurality of contact pads exposed through an opening in the housing base, the plurality of contact pads including two contact pads that are electrically connected to a first end and a second end of the compound wire,
wherein the coil is operable to generate an alternating current in the compound wire at a low frequency in a range between 300 kHz and 400 kHz and at a high frequency in a range between 1 MHz and 2 MHz.

2. The transmitter coil module of claim 1 wherein each basic bundle includes four strands.

3. The transmitter coil module of claim 2 wherein each compound bundle includes four basic bundles.

4. The transmitter coil module of claim 3 wherein the compound wire includes seven compound bundles.

5. The transmitter coil module of claim 1 wherein the plurality of turns of the compound wire are arranged in a single layer.

6. The transmitter coil module of claim 1 further comprising:
a ferrimagnetic sleeve disposed around a distal surface of the coil; and
an electromagnetic shield disposed between a proximal surface of the coil and the cap.

7. The transmitter coil module of claim 1 wherein the low frequency is 326 kHz and the high frequency is 1.78 MHz.

8. A wireless charging kit comprising:
a transmitter coil module comprising:
a housing including a cap and a housing base forming a sealed enclosure;
a coil formed of a compound wire wound into a plurality of turns,
wherein the compound wire comprises a plurality of strands, wherein subsets of the strands are twisted around each other to form a set of basic bundles, wherein groups of basic bundles are twisted around each other to form a plurality of compound bundles, and wherein the plurality of compound bundles are twisted around each other to form the compound wire; and
a control module comprising a printed circuit board having electronic components mounted thereon, the electronic components including control circuitry configured to generate an alternating current in the compound wire at a low frequency in a range between 300 kHz and 400 kHz and at a high frequency in a 1-2 MHz range.

9. The wireless charging kit of claim 8 wherein each basic bundle includes four strands.

10. The wireless charging kit of claim 9 wherein each compound bundle includes four basic bundles.

11. The wireless charging kit of claim 10 wherein the compound wire includes seven compound bundles.

12. The wireless charging kit of claim 8 wherein the plurality of turns of the compound wire are arranged in a single layer.

13. The wireless charging kit of claim 8 wherein the transmitter coil module further comprises:
a ferrimagnetic sleeve disposed around a distal surface of the coil; and
an electromagnetic shield disposed between a proximal surface of the coil and the cap.

14. The wireless charging kit of claim 8 wherein the low frequency is 326 kHz and the high frequency is 1.78 MHz.

15. The wireless charging kit of claim 8 wherein the printed circuit board has a first plurality of contact pads for outputting AC current at a first end.

16. The wireless charging kit of claim 15 wherein the printed circuit board has a second plurality of contact pads for USB power and data at a second end opposite the first end.
